(19) United States
(12) Patent Application Publication
(10) Pub. No.: US 2004/0130899 A1
(43) Pub. Date: Jul. 8, 2004

(54) Decorative illumination and display device and method

(76) Inventors: Marjorie Skouras, Los Angeles, CA (US); Alison Blumenfeld, Los Angeles, CA (US)

Correspondence Address: Mimi Chiang, 1288 Calle de Sevilla, Pacific Palisades, CA, 90272, US

(21) Appl. No.: 10/726,291

(22) Filed: Dec. 2, 2003

Related U.S. Application Data
(60) Provisional application No. 60/430,417, filed on Dec. 2, 2002.

(51) Int. Cl. F21V 11/00

(52) U.S. Cl. 362/351

(57) ABSTRACT

An illumination display device such as a lamp shade includes a base for coupling a light source thereto, an outer structure having a bottom and a generally continuous inner peripheral surface surrounding the light source when coupled to the base, and an inner structure disposed within the outer structure and having an outer peripheral surface configured to cooperate with the inner peripheral surface of the outer structure to define an externally accessible volume therebetween for displaying objects therein.

### RELATED APPLICATIONS

This patent application claims the priority of U.S. Provisional Patent Application Serial No. 60/430,417, filed Dec. 2, 2002, the entire contents of which are incorporated herein by reference thereto.

### TECHNICAL FIELD

This patent application is in the field of illumination display devices, and more particularly illumination devices that may be repeatedly customized by a user to also serve a decorative purpose by displaying objects selectable by the user.

### BACKGROUND OF THE INVENTION

Illumination devices are found everywhere, from factories to offices and hospitals, and private homes. Besides fulfilling a very important utilitarian function, i.e. to shed light, illumination devices have also been used to serve decorative purposes. To this end, a wide variety of illumination devices (lamps, chandeliers, wall sconces, candles, etc.) and attachments for illumination devices (lamp shades, wall sconce shades, candle holders, etc.) have been especially designed to be decorative as well as to fulfill the main function of casting light about their surroundings.

As known in the art, such devices and attachments are typically designed so as to provide a pleasing form to be looked upon by a user, or to cooperate with the light emitting element(s) of the illumination device to cast decorative shadows and/or colors and/or patterns.

For instance, U.S. Pat. No. 2,177,204 to Buzick et al. discloses picture display panels for a lampshade formed of two-ply material, wherein the outer ply is transparent and the inner ply being translucent and the shade is slotted to allow the placement of a picture or the like. This lampshade will only accept pictures or other sheets of paper for display, of only a limited size. Furthermore, the picture display panels are obvious and may not be considered attractive by all users.

U.S. Pat. No. 2,680,317 to Lewis discloses a decorative lampshade having a fenestration 20 with a background plate 21. Art 22 in sheet form such as a pictorial print etching or the like is adhered or otherwise appropriately mounted on the face of background plate 21. This lampshade is also limited to a certain size of art, and has a bulky appearance with an obvious, unattractive window 20.

U.S. Pat. No. 2,823,477 to Willard teaches a lampshade having either opaque or translucent material and behind which pictures or colored panels of translucent or transparent material may be mounted. This arrangement is similar to the configuration of Lewis '317, and is similarly limited in the size and type of art it can accept for display.

U.S. Pat. No. 2,974,435 to Eschenroeder is directed to a lampshade of separable double-walled construction comprising an inner wall of translucent material positioned adjacent to a light source, and a generally opaque outer wall having one or more transparent image display windows whereby an image carrying sheet may be detachably mounted between the walls in alignment with the window. The appearance of this lampshade is similar to Lewis '317 and Willard '477, and similarly limited to certain sizes and types of art to display.

A similar lampshade is disclosed in U.S. Pat. No. 4,163,998 to Anderson, which is formed with a window opening in which a picture may be mounted between inner and outer of at least partially transparent sheets located against the inner surface of the lampshade for display. Similarly, U.S. Pat. No. 3,456,106 to Gluschkin discloses a frusto-conical lampshade capable of receiving decorative or information carrying members.

Published U.S. patent application Ser. No. 20030218883 discloses an image display device that may be formed into a lampshade, and is comprised of an inner translucent layer coupled to an outer transparent layer with a narrow space therebetween, and having sleeve-type structures attached thereto for engaging projections of a supporting base such as a lamp base. This device accepts only sheets of paper such as photographs and the like for display, that are limited in width to the dimensions of the inner layer. This device also requires a base that is formed with projections such as spokes and the like that can engage the mounting sleeves of the device for securing thereto.

What is still needed are methods and devices to enable a consumer to customize the decorative configuration of an illumination device in accordance with the individual taste and requirements of the consumer that offer a wider variety of options regarding the objects that may be used to decorate with or display, that is simple in construction and aesthetically pleasing in appearance, and that may be constructed using a wide variety of materials. The embodiments disclosed herein meet these and other needs.

### SUMMARY OF THE INVENTION

In one embodiment disclosed herein, a lamp shade includes an outer structure having a generally continuous inner peripheral surface, an inner structure disposed within the outer structure, the inner structure having an outer peripheral surface configured to cooperate with the inner peripheral surface of the outer structure to define an externally accessible volume therebetween, and further having an inner peripheral surface for surrounding a light source; and a base for coupling the light source thereto and for coupling to at least one of the structures.

In another embodiment disclosed herein, a method for forming a lamp shade includes providing a base for mounting a light source thereto, mounting an outer structure to the base, the outer structure having a generally continuous peripheral surface for surrounding the light source when mounted to the base, and disposing an inner structure within the outer structure, the inner structure having a peripheral surface configured to cooperate with the peripheral surface of the outer structure to define an externally accessible volume therebetween.

In a further embodiment disclosed herein, a method for displaying objects includes disposing an inner structure around a light source, the inner structure having a peripheral surface, disposing an outer surface around the inner structure, the outer structure having a peripheral surface configured to cooperate with the peripheral surface of the inner structure to define an externally accessible volume therebetween, and disposing one or more objects within the externally accessible volume for display therein.

These and other features and advantages will become further apparent from the detailed description and accompanying figures that follow. In the figures and description, numerals indicate the various features, like numerals referring to like features throughout both the drawings and the description.

### BRIEF DESCRIPTION OF THE DRAWINGS

FIG. 1 is a side perspective view of an exemplary embodiment of a device as described herein;

FIG. 2 is a side perspective view of an exemplary embodiment of a device as described herein;

FIG. 3 is a side perspective view of an exemplary embodiment of a device as described herein;

FIGS. 4A-B are bottom perspective views of exemplary embodiments of a device as described herein;

FIG. 5 is an exploded perspective view of another device as disclosed herein;

FIG. 6 is a top view of the assembled device of FIG. 5;

FIG. 7 is a perspective view of a method of use of the assembled device of FIG. 5;

FIG. 8 is a perspective view of the device of FIG. 6 in use for displaying printed matter;

FIG. 9 is a perspective view of another embodiment of a device as disclosed herein; and

FIG. 10 is a perspective view of a further embodiment of a device as disclosed herein.

### DETAILED DESCRIPTION

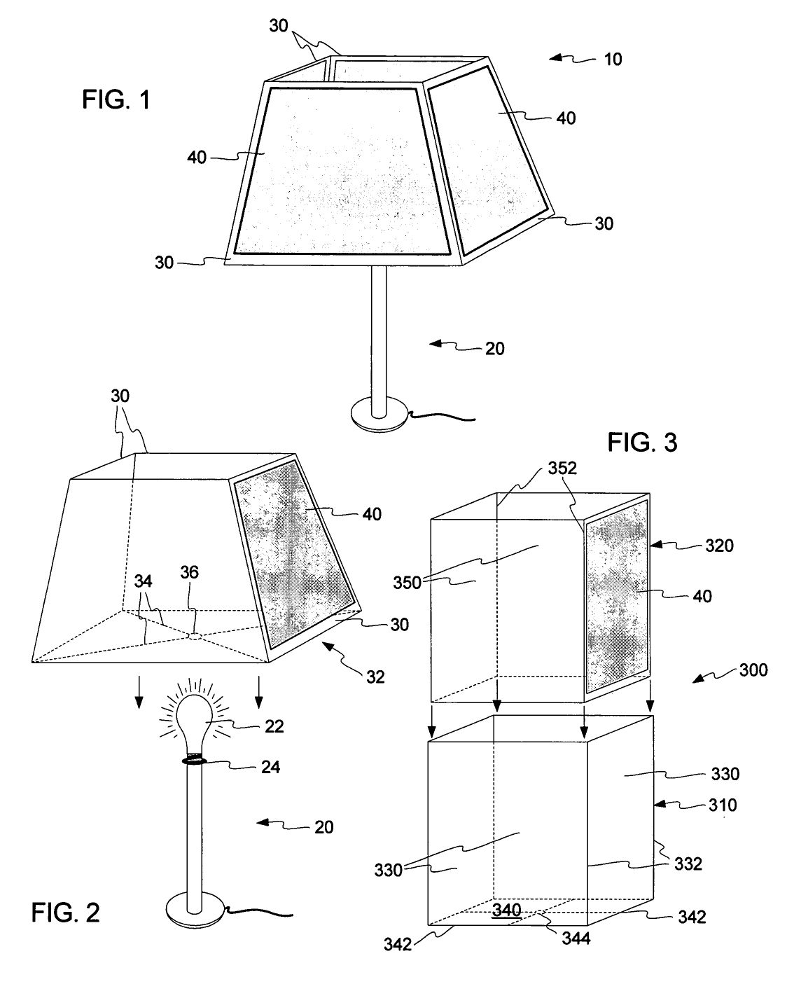

With reference to FIG. 1, an attachment 10 for an illumination device 20 is configured in the form of a lamp shade that includes, for purpose of illustration only, four surfaces 30 joined to one another to form a generally cubic volumetric structure to enclose one or more light emitting elements of the illumination device 20, shown in the embodiment of FIG. 1 as a lamp. With additional reference to FIG. 2, lamp 20 includes light bulb 22 as a light emitting element. Light bulb 22 is shown held in receptacle 24 that is also formed with engagement means such as circumferential threads (not shown).

Lamp shade 10 is shown to include base 32, formed of at least one support, or two or more arms or supports, or preferably three or four arms or supports 34 extending from the surfaces 30 to center ring 36. Center ring 36 is formed to engage the engagement means on lamp 20 to be held securely thereby. As is well known in the art, the engagement means on lamp 20 typically include a threaded light bulb socket that receive center ring 36 thereover and which can then be secured therein by a threaded cap that threadably engages the socket and is tightened thereon to secure the center ring 36 therebetween.

With continued reference to FIGS. 1 and 2, surfaces 30 of lamp shade 10 may be formed in the manner of picture frames configured to secure or house images 40 therein. Images 40 may be any two-dimensional material, including paper, film, cloth, silk, parchment, plastic, synthetics, metals, sheets, and the like, capable of displaying an image thereon. In one method of use of the embodiment disclosed, a user may choose one or more images 40, such as pictures, photographs, drawings, art, and the like, and insert one or more image(s) into each surface or frame 30 as practicable and desired. The user may then secure the lamp shade 10 to the lamp 20 and power the lamp on so that light bulb 22 may emit light. Optionally, the lamp shade 10 will already be secured or will be secured to the lamp 20 prior to user insertion of image(s). By placing the lamp shade 10 so as to surround light bulb 22, light emitted by the light bulb passes from behind and at least partially through each of images 40 to light up the images for any viewer gazing upon the lamp. Optionally, the images are also viewable when the light bulb is not emitting light (i.e. turned off).

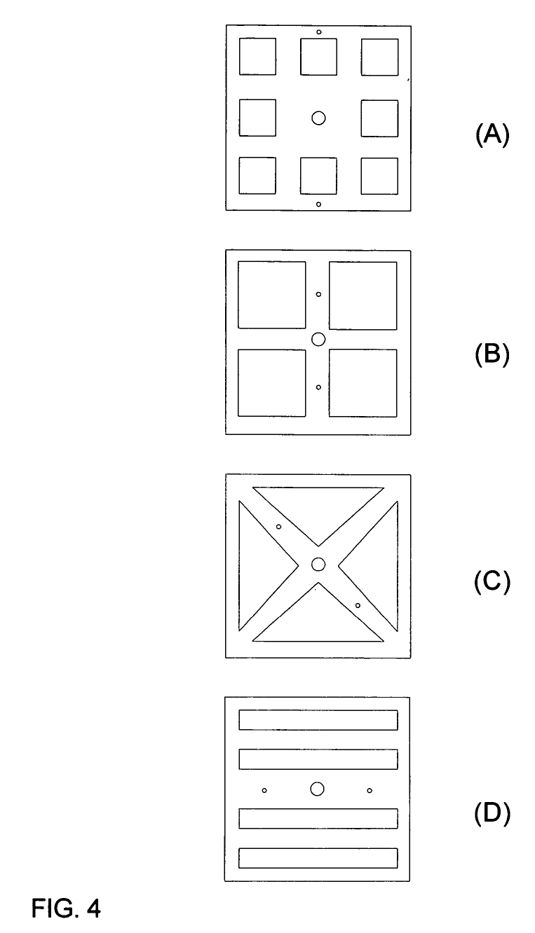

With reference now to FIG. 3, another embodiment of an illumination device as disclosed herein includes lamp shade 300, formed of base 310 and insert 320. Base 310 may be formed of four surfaces 330 joined to one another along mutual edges 332 to form a generally cubic volume as described previously. If desired, base and insert may be formed of 3 or more surfaces. The overall configured shape of the shade will correspond to the geometric structure formed by the base and insert. For example, a shade comprising 3 surfaces would form a generally pyramidal shaped shade. A shade comprised of 6 surfaces would form a generally hexagonal shaped shade. A shade comprised of 8 surfaces would form a generally octagonal shaped shade and so forth. Base 310 may further be formed with a bottom plate 340 coupled to or joined to each of the surfaces 330 along mutual edges 342. Bottom plate 340 may also include aperture 344 formed at a central location for securing the lamp shade 300 to an illumination device such as lamp 20. Aperture 344 does not have to be formed at a central location within bottom plate 340, but it may be preferable to provide the aperture at a location that will aid securing the lamp shade 300 to the lamp 20 in a balanced configuration and thereby reduce stresses placed upon the lamp shade, the base, and/or the lamp. Referring to FIGS. 4A-B, additional exemplary base configurations are shown.

Insert 320 of lamp shade 300 is shown formed with four surfaces 350, each complementary to a surface 330 of base 310, and joined to one another along mutual edges 352 to form a generally cubic volume that may slide inside base 310 as shown in FIG. 3. Preferably, insert 320 is formed in a configuration that will slide into base 310 snugly and leave only sufficient space between each base surface 330 and complementary insert surface 350 for an image 40 to be inserted therebetween. In a method of use of lamp shade 300, a user may choose one or more images, including pictures, photographs [any combination or type of photograph], drawings, artwork, silk-screen, etchings, pieces of cloth, plastic or other materials, dried pressed flowers, or any other article that is generally flat and sufficiently thin, and apply them to the outer sides of surfaces 350 of insert 320. The user may then proceed to slide insert 320 into base 310, paying care that none of the images applied to insert 320 come loose. Alternatively, the user may first slide insert 320 into base 310 and then slide images 40 in the interstitial space between the surfaces 330 of the base and the surfaces 350 of the insert. This latter method is preferable when the image is substantially flat such as for example, a photograph such as a black and white, color or sepia toned photograph.

The number and size of an image(s) inserted per side of the shade will be limited only by the overall dimensions of each lamp shade surface. For example, a lamp shade surface having dimension 8.5″ W×10.5″ H or less will allow insertion of a single 8×10″ photograph or insertion of one or more photographs of smaller dimension. The overall dimensions of each lamp shade surface can vary as desired. This affords greater artistic freedom to the user as he/she may form one or more collages of user-selected photos, portrait artwork, or pictures, or may if desired, form a lamp shade comprising multiple copies of the same photographic image. Applying images to the insert prior to sliding it into the base also affords artistic freedom to the user as she may form collages and mixed-media compositions that would otherwise be more difficult to form if each image had to inserted into the desired interstitial space between the base and the insert. The number and layout of images can be personalized as desired by user. After insert 320 has been slid into base 310, bottom plate 340 of the base will maintain the insert within the base and also allow the user to attach the lamp shade 300 to a lamp, such as via the aperture 344. If desired, the bottom plate 340 may have additional attachment means as indicated in FIG. 4 to aid in securing the lamp shade.

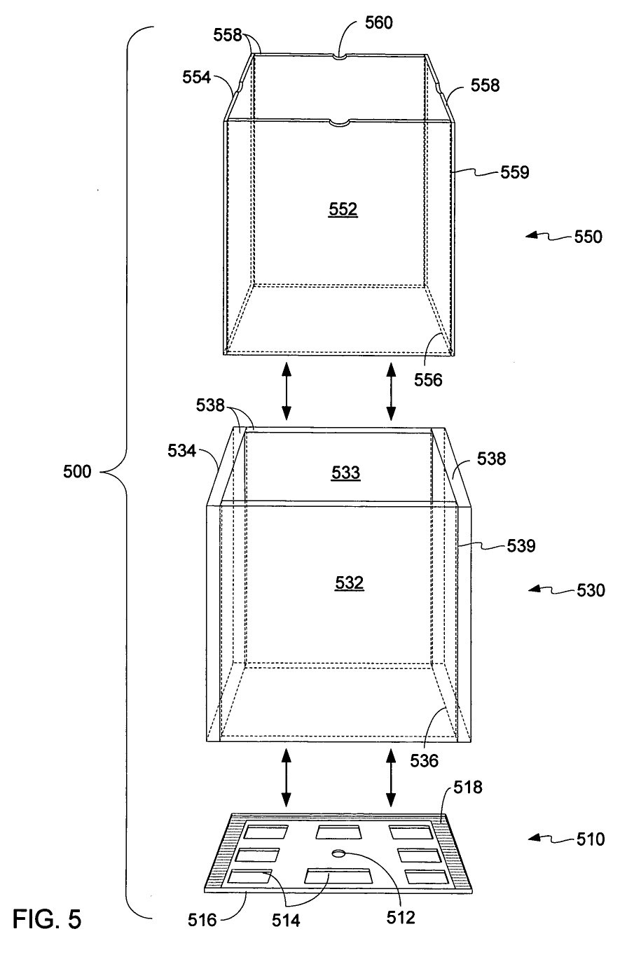

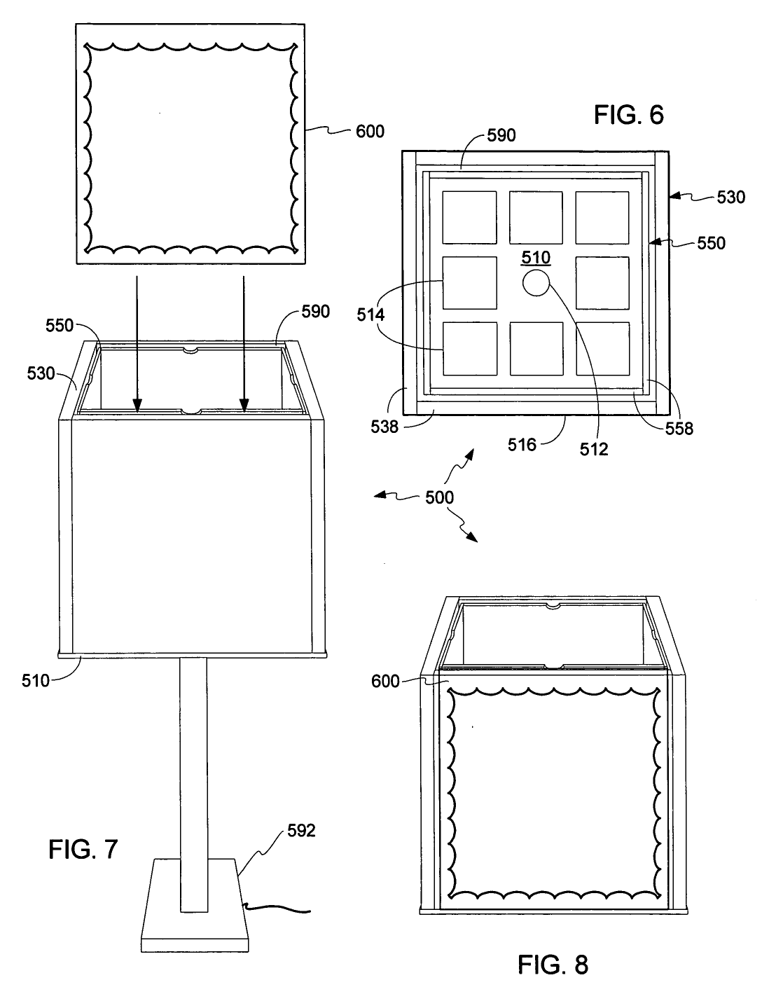

With reference now to FIG. 5, a further embodiment is directed to an illumination display device 500 for use in concert with a light source such as one or more light bulbs, candles, etc., that are to be disposed within the device 500 and thus emit their light outwardly through the device 500. The embodiment of illumination display device 500 shown includes a base 510, an outer structure 530, and an inner structure 550. The inner structure 550 is configured to be disposed within the outer structure 530 and to cooperate therewith to define an externally accessible volume 590 therebetween as shown in, and discussed in further detail with reference to, FIG. 6. The outer structure 530 is configured to be coupled to or mounted to the base 510 by any means practicable, including but not limited to gluing, melting, acid (or chemical) adhesion, welding, and fastening with mechanical fasteners such as screws, bolts, and the like, as easily selectable and practicable by those of ordinary skill in the art. Optionally, the outer structure 530, and the inner structure 530 when disposed within the outer structure, may both be configured to be coupled to or mounted to the base 510, or the inner structure 550 may be configured to be coupled to or mounted to the base 510.

The base 510 is preferably a monolithic structure such as a flat plate, and includes means 512 for securing a light source or light emitting source thereto, such as light bulbs, candles, reflectors, etc. Optionally, the means 512 for securing a light source can be configured so as to allow rotation or movement of the base 510 around the light source. For example, the means can be configured or constructed such that the lamp shade can swivel or rotate along the lamp shade's or base plate's horizontal axis. Alternatively, the base may be formed for coupling or mounting to a stand such that the base can rotate about a vertical axis with respect to the stand. In the embodiment shown, aperture 512 is formed to receive a light bulb therein, and may be further configured to enable mounting the base 510 to a stand such as a lamp stand 592 as well known to those of ordinary skill in the art and as shown in, and discussed in further detail with reference to, FIG. 6. Because light sources generally also generate heat, it may be preferable to form the base 510 with adequate ventilation means such as apertures 514 that act to allow airflow through the entire device 500. As previously shown in FIGS. 4A-D, numerous other ventilation aperture configurations may be practiced with the embodiments disclosed herein, none of which are intended as a limitation upon the scope of the claims appended hereto.

With continued reference to FIG. 5, outer structure 530 is formed with a continuous outer peripheral surface 532, a continuous inner peripheral surface 533, an open top 534 and, in the embodiment illustrated, an open bottom 536. The open bottom 536 and open top 534 cooperate with the ventilation apertures 514 in the base 510 to allow airflow through the illumination display device 500. The open top 534, as later described in detail, also allows the placement of objects for display within the assembled illumination display device 500. The outer structure 530 is preferably formed from an at least partially light transmissive material, which may, but is not limited to any of plastics, glasses, ceramics, metals, synthetics, composites, fabrics, woven fabrics, textiles, and any combination thereof. In the embodiment shown, the outer structure 530 is formed from four planar, generally square or rectangular sheets 538 of material, each joined to each of two other sheets along its vertical edges 539, respectively. In this manner, the continuous outer and inner peripheral surfaces 532, 533 are formed of four planar surfaces joined at right angles to each other. The method of joining the sheets 538 of material is not material to the practice of the embodiments disclosed herein, but it is noted that it may be found desirable to choose a method that will form a or result in a seamless, visually seamless, or nearly-seamless joint between adjoining sheets of material so that the joints do not reflect or refract light and thereby detract from the aesthetics of the device 500. Thus, it may be desirable to polish the edges 539 of the sheets 538 of material, such as mechanically by grinding or sanding or chemically such as with acid, or acid-based adhesion, to form a smooth, non-refractive surface along each edge. Alternatively, the edges 539 of the sheets 538 of material may be polished by heating or other means of melting, adhering or attaching, so as to result in visually seamless joining, or joints that do not reflect or refract light.

It must be clearly noted and understood that the outer structure 530 may be formed with any other type and configuration of outer and inner peripheral surfaces 532, 533, including but not limited to curved, cylindrical, frusto-conical, and multi-faceted wherein the individual facets may be of any shape and configuration, including different shapes and configurations within the same outer structure, and wherein the individual facets may be joined at various angles to one another, including varying angles within the same outer structure.

Still referring to FIG. 5, the inner structure 550 is also formed with a continuous outer peripheral surface 552, which in the embodiment shown also consists of four planar, generally square or rectangular sheets 558 of material joined along respective vertical edges 559. The inner structure 550 is configured in shape and size so as to be disposed within the outer structure 530 and optionally, mounted to the base 510. The inner structure 550 may also be formed from an at least partially light transmissive material, as previously disclosed with reference to the outer structure 530. It may further also be found desirable to similarly form seamless or visually seamless joints between the sheets 558 of material to thereby enhance the aesthetics of the device 500. The inner structure is further formed with an open top 554 and an open bottom 556, to thereby also cooperate with the ventilation apertures 514 in the base 510 to allow airflow through the device 500. The inner structure 550 may further be formed with one or more access cut-out(s) or notches 560 along its top 538, such as along the upper edges of one or more of the sheets 558 of material forming the inner structure.

To securely hold or place the outer structure 530 and/or the inner structure 550 to the base 510, the base may be formed with a lip 516 extending around the periphery of the base and sized to receive the bottom 536 of the outer structure 530 snugly therein. The base may also, or alternatively, be formed with a groove or track 518 configured to receive the outer structure 530 and/or the inner structure 550 therein. Furthermore, the outer and inner structures 530, 550 are shown herein as constructed with butt joints between the sheets 538, 558 of material, but any other type of joint may be practiced, and the outer and inner structures may also be cast as integral, monolithic structures such as by injection molding, hot or cold rolling, etc. In an alternative embodiment, a planar frame may be provided to extend along the bottom 536 of the outer structure 530 so as to be disposed between the outer structure 530 and the base 510 or adjacent to the base 510. Alternatively, a planar frame may be provided to extend along the bottom 556 of the inner structure 550 so as to be disposed between the inner structure 550 and the base 510 or adjacent to the base 510. The planar frame may be formed with a substantially open interior to cooperate with the ventilation apertures 514 in the base 510 to allow airflow through the device 500. The planar frame may further be configured such that the inner structure 550 rests upon the planar frame when the inner structure is disposed within the outer structure 530. The planar frame may also, if desired, be configured to include one or more attachment means thereby allowing for either the outer structure 530, and/or optionally, the inner structure 550, to be secured, coupled or mounted to the base 510. For example, the planar frame may be configured so as to extend from the outer structure 530 inward toward the center of the lamp shade, away from the inner surface 532 of the outer structure, or along the bottom of the outer structure, thus forming a lip region of the outer structure. Such a planar frame could be configured so as to have a periphery configuration substantially corresponding to the periphery configuration of the base, thereby also securing the outer structure to the base. Alternatively, the planar frame can include one or more attachment means such as a tapped hole(s) or screw hole(s) thereby allowing the outer structure 530 or inner structure 550 to be secured to the base 510. A planar frame may be provided to extend along the bottom 536 of the inner structure 550 and formed so as to cooperate with the base 510 to allow airflow through the device 500 and/or so as to secure the inner structure 550 to the base 510. Variations of the above configurations are also envisioned as desired.

Referring to FIG. 6, a top view of the assembled device 500 is shown, with the inner structure 550 disposed with the outer structure 530 to define the externally accessible volume 590 therebetween. Ventilation apertures 514 of the base 510 are also visible.

With reference now to FIG. 8, in one method of use of the illumination display device 500 of FIG. 5, the inner structure 550 is disposed within the outer structure 530, and one or both structures are coupled or mounted to the base 510. The illumination display device 500 may be employed as a lamp shade and thus may be attached to a lamp 592, with the light bulb or light bulbs of the lamp disposed within the device 500 to cast light outwardly therethrough. Importantly, the inner structure 550 is formed with an outer peripheral surface 552 that is configured to be spaced from and cooperate with the inner peripheral surface 533 of the outer structure 530, when the inner structure is disposed within the outer structure and both are place with the base 510, so as to define an externally accessible volume 590 therebetween having a predetermined volumetric capacity and geometric configuration. The volume 590 is accessible through the open top of the outer structure 530, and thereby enables a user to dispose any object or objects within the device 500 for display therein. The type and number of objects that can thus be displayed is limited solely by the size and shape of the volume 590. In a typical use, the volume 590 may be sized so as to accept thin planar objects such as sheet of paper 600 containing photographs, film, photo artwork, art, etc., or dried pressed leaves or flowers, or textiles, or graphics, or graphic artwork, or any combination thereof. As shown in FIG. 8, the sheet 600 may be slid or inserted inside the volume 590 for display therein, and may be easily removed by a user as aided by the access notch 560.

Alternatively, the volume 590 may be sized so as to accept bulkier objects therein, such as rocks, crystals, glass beads, sand, sea shells, fabrics, textiles, collectibles, etc. If the placement or mounting of the inner and outer structures 530, 550 to the base 510 is formed with a sufficient seal, a liquid may also be disposed within the volume 590. In one embodiment, the monolithic, uninterrupted configuration of the volume 590 allows greater artistic freedom in disposing objects within the volume, as such objects may be bent around the corners of the inner structure 550 if so desired. This advantage is achieved by forming the inner and outer structures 550, 530 with substantially continuous outer and inner peripheral surfaces 552, 533 respectively, and is further enhanced by not mounting the inner structure and the outer structure to one another.

It must be understood that the configuration of the volume 590 is limited solely by the imagination of one practicing the embodiments disclosed herein, and all such configurations and/or sizes are encompassed within the scope of the claims appended hereto. Thus, the inner structure 550 may be formed with an outer peripheral surface 552 having any shape or size that will allow it to be disposed within the outer structure 530, and is by no means limited to a configuration that is substantially similar to the outer and/or inner peripheral surfaces 532, 533 of the outer structure as shown in the embodiment of FIGS. 5-8. Thus, the outer structure 530 may be formed with a different configuration than the inner structure 550, thereby cooperating to define an irregular volume 590 or space therebetween. The inner and outer structures need not be sized to match. The inner structure may be configured to be smaller or larger than the outer structure, and vice-versa. The inner structure 550 and/or outer structure 530 may be disposed upon a rotating plate or functionally similar means within the base 510 so as to be able to move or rotate for enhanced artistic effect.

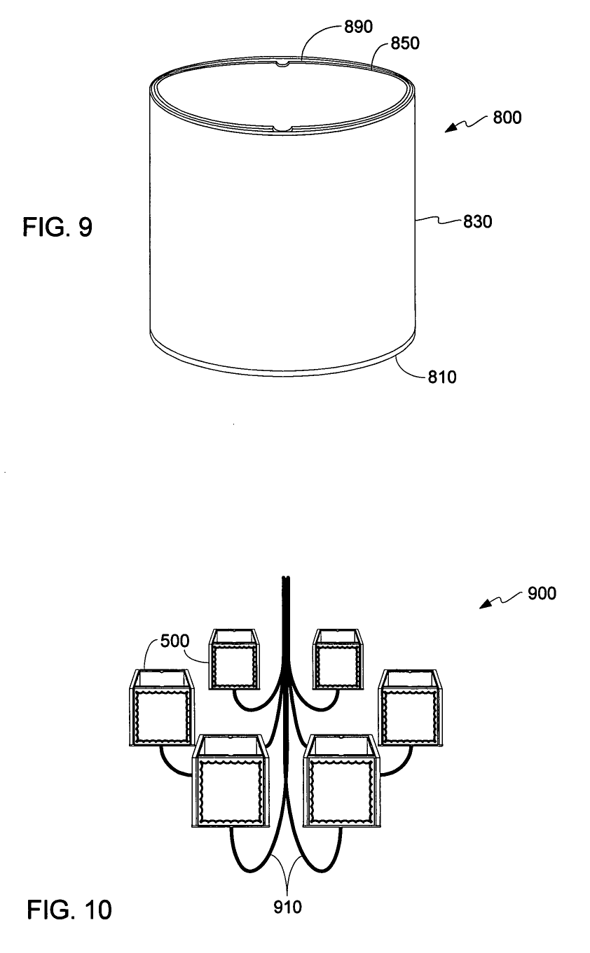

Similarly, the outer structure 530 may also be formed with any configuration desirable. For illustration purposes only, and as a further example of the many possibilities achievable by practicing the teachings of the present disclosure, another embodiment of an illumination display device 800 is shown in FIG. 9, wherein substantially cylindrical outer and inner structures 830, 850 are concentrically disposed and mounted onto a appropriately configured, substantially circular base 810 to define a generally toroidal volume 890 therebetween for accepting objects within for display therein.

The materials of construction that may be selected for making any embodiment as described herein should preferably be at least semi-transparent to light. The materials may also be selected to offer resistance to heat, to thereby allow the use of higher-output light emitting elements (e.g. higher wattage light bulbs) or flame-retardent to allow use of a candle(s) or other flame-emitting element. It may also be found desirable to select materials that are mechanically strong enough to form a sufficiently sturdy attachment for engagement to an illumination device such as a lamp. Thus, materials that may be considered for forming the base 310, 510 include metals, ceramics, plastics, wood, glass, composites, synthetics and any combination thereof. Further, the device may be manufactured or constructed to conform with manufacturing guidelines such as the guidelines of UL Manual 1598, entitled “Luminaries in General”, or UL Manual 153 entitled “Portable Electric Luminary Devices”, or any other applicable governmental, agency or UL guideline.

Other illumination devices for which the attachments disclosed herein may be formed include wall sconces, or any other type of illuminating device typically attached to a wall, structure, or upright structure. An attachment as disclosed herein may thus provide a single surface to hold one or more images therein for display. The illumination device may also be a chandelier or overhead lamp, in which case the attachment may be formed as a lamp shade to encircle the chandelier or overhead lamp, or alternatively multiple smaller attachments may be formed for attachment to each individual light emitting element of the chandelier or overhead lamp. Such an embodiment is shown for illustration purposes only, in FIG. 10, wherein multiple illumination display devices 500 are mounted onto multiple arms 910 having light bulbs thereon, to form a chandelier 900 suitable for ceiling mounting.

The embodiment of the illumination display device 500 of FIGS. 5-8 may be formed to accept standard size photographs, such as 4″×6″, 5″×7″, 10″×8″, 10″×10″,11″×14″, etc.. It has been found that a material of construction having desirable properties for constructing the inner and outer structures 550, 530 is acrylic. It has been found that 0.25″ thick acrylic is suitable for forming the outer structure 530, and 0.125″ thick acrylic is suitable for forming the inner structure 550. Using such acrylic sheets, an illumination display device 500 for displaying 10″×8″ photographs may be formed from four sheets 538 of acrylic that are about 8.0″-8.25″ high, with two opposing sheets being about 10.0″-10.5″ wide and the other two opposing sheets being about 10.0″-10.5″ wide, and a planar frame, (or outer box base) being about 0.25″ thick and 10.5″×10.5″ square, forming about 1.5″ lip along all four sides. The resulting outer box having five sides and about 8.25″×10.5″×0.25″ dimension. The planar frame forming the fifth side having a hole within each of two opposing sides to allow insertion or attachment to the base. Similarly, an illumination display device 500 for displaying 10″×10″ photographs may be formed from four sheets 538 of acrylic that are about 10.25″ high, with two opposing sheets being about 10.5″ wide and the other two opposing sheets being about 10″ wide. An illumination display device 500 for displaying 11″×14″ photographs may be formed from four sheets 538 of acrylic to form an outer box of about 11.5″×14.5″×0.25″ dimension. Each sheet 538 being of about 14.0″-14.25″ high, with two opposing sheets being about 11.0″-11.5″ wide and the other two opposing sheets being about 11″ wide. The planar frame sheet being about 11.5″×11.5″ forming a 1.5″ lip on all four sides. The planar frame sheet forming a fifth side of the final outer box. The planar frame sheet having tapped screw holes of about 3/32″ centered on two opposing sides of the formed lip. The base 510 may be formed of metal and configured so as to have about a 0.625″ height lip, with ventilation apertures formed therein as previously disclosed. It has been found that forming the ventilation apertures in a symmetrical pattern will spread the stress of the weight of the outer and inner structures upon the base in an even manner and thus allow the use of a thinner base or thinner outer or inner structure, which may be found to be more aesthetically pleasing by consumers. It has also been found that a base having more than 4 ventilation apertures also provides a base having sufficient support so as to prevent bowing or buckling when supporting the assembled lamp shade.

In addition to the above embodiments and suggestions, numerous modifications may be made to illumination display devices as disclosed herein without departing from the scope and spirit of the claims appended hereto, and those skilled in this art will understand how to make changes and modifications to the present disclosure to meet their specific requirements or conditions.

What is claimed is:

1. A lamp shade, comprising:
an outer structure having a generally continuous inner peripheral surface;
an inner structure disposed within the outer structure, the inner structure having an outer peripheral surface configured to cooperate with the inner peripheral surface of the outer structure to define an externally accessible volume therebetween, and further having an inner peripheral surface for surrounding a light source; and
a base for coupling the light source thereto and for coupling to at least one of the structures.

2. The lamp shade of claim 1, wherein the outer structure comprises:
a plurality of substantially planar vertical surfaces.

3. The lamp shade of claim 2, wherein the outer structure comprises:
at least three planar, rectangular surfaces, each surface being joined to each of two adjoining surfaces along each of its two vertical edges, respectively.

4. The lamp shade of claim 3, wherein the outer structure and the inner structure are formed with generally open bottoms.

5. The lamp shade of claim 4, wherein the outer structure and the inner structure are formed with generally open tops.

6. The lamp shade of claim 5, wherein the inner structure is configured substantially similar to the outer structure and is sized to define an externally accessible volume therebetween for removably receiving at least one sheet of printed matter therein through the outer structure open top.

7. The lamp shade of claim 6, wherein at least one planar surface of the inner structure has an opening formed therein to provide access to printed matter disposed within the externally accessible volume.

8. The lamp shade of claim 6, wherein the outer structure is formed from a transparent or a semi-transparent material.

9. The lamp shade of claim 8, wherein the outer structure is formed from a material selected from the group of materials comprised of plastics, glasses, ceramics, metals, woven fabrics, and any combination thereof.

10. The lamp shade of claim 8, wherein the outer structure is formed from acrylic.

11. The lamp shade of claim 1, wherein the base is further formed for mounting to a stand.

12. The lamp shade of claim 11, wherein the base is configured to allow airflow therethrough and through the inside of the inner structure.

13. The lamp shade of claim 6, wherein the base is formed as a substantially planar surface having a periphery configuration substantially corresponding to the bottom of the outer structure.

14. The lamp shade of claim 13, wherein the base is formed with a groove extending along the inside of its periphery to receive the outer structure therein.

15. The lamp shade of claim 11, wherein the base is formed from a material selected from the group of materials comprised of plastics, glasses, ceramics, metals, and any combination thereof.

16. The lamp shade of claim 1, wherein the outer structure and the inner structure are formed with generally open bottoms.

17. The lamp shade of claim 16, wherein the outer structure and the inner structure are formed with generally open tops.

18. The lamp shade of claim 17, wherein the base is configured with apertures therein to allow airflow therethrough and through the inside of the inner structure.

19. The lamp shade of claim 1, wherein the outer structure is formed from a transparent or a semi-transparent material.

20. The lamp shade of claim 1, wherein the inner structure is formed from a light transmissive material.

21. The lamp shade of claim 20, wherein the outer structure is formed from a material selected from the group of materials comprised of plastics, glasses, ceramics, metals, woven fabrics, and any combination thereof.

22. The lamp shade of claim 11, wherein the base is formed from a material selected from the group of materials comprised of plastics, glasses, ceramics, metals, and any combination thereof.

23. The lamp shade of claim 1, wherein the outer structure comprises:
a substantially cylindrical vertical surface.

24. The lamp shade of claim 1, wherein the outer structure comprises:
a substantially frusto-conical vertical surface.

25. The lamp shade of claim 1, wherein the outer structure comprises:
a plurality of substantially planar angled surfaces.

26. The lamp shade of claim 1, wherein the base comprises:
a base for mounting one or more light bulbs thereto.

27. The lamp shade of claim 1, wherein the base comprises:
a surface for holding one or more candles.

28. A method for forming a lamp shade, comprising:
providing a base for coupling a light source thereto;
coupling an outer structure to the base, the outer structure having a substantially continuous inner peripheral surface for surrounding the light source when coupled to the base;
selecting an inner structure wherein the inner structure has an outer peripheral surface configured to cooperate with the inner peripheral surface of the outer structure; and
disposing the inner structure within the outer structure so that the outer peripheral surface of the inner structure is spaced from the inner peripheral surface of the outer structure to define an externally accessible volume therebetween.

29. The method of claim 28, wherein the outer structure comprises:
a plurality of substantially planar vertical surfaces.

30. The method of claim 29, wherein the outer structure comprises:
at least three planar, rectangular surfaces, each surface being joined to each of two adjoining surfaces along each of its two vertical edges, respectively.

31. The method of claim 30, wherein the outer structure and the inner structure are formed with generally open bottoms.

32. The method of claim 31, wherein the outer structure and the inner structure are formed with generally open tops.

33. The method of claim 32, wherein the inner structure is configured substantially similar to the outer structure and is sized to define an externally accessible volume therebetween for removably receiving at least one sheet of printed matter therein through the outer structure open top.

34. The method of claim 33, wherein the planar surfaces of the inner structure have openings formed therein to provide access to printed matter disposed within the externally accessible volume.

35. The method of claim 33, wherein the outer structure is formed from a transparent or a semi-transparent material.

36. The method of claim 35, wherein the outer structure is formed from a material selected from the group of materials comprised of plastics, glasses, ceramics, metals, woven fabrics, synthetics, composites, and any combination thereof.

37. The method of claim 35, wherein the outer structure is formed from acrylic.

38. The method of claim 32, further comprising:
disposing one or more objects within the externally accessible volume for display therein.

39. The method of claim 28, wherein the base is configured to allow airflow therethrough and through the inside of the inner structure.

40. The method of claim 33, wherein the base is formed as a substantially planar surface having a periphery configuration substantially corresponding to the bottom of the outer structure.

41. The method of claim 40, wherein coupling the outer and inner structures comprises:
disposing the outer and inner structures within a groove extending along the inside of the periphery of the base.

42. The method of claim 28, wherein the base is formed from a material selected from the group of materials comprised of plastics, glasses, ceramics, metals, synthetics, composites, and any combination thereof.

43. The method of claim 28, further comprising:
disposing one or more objects within the externally accessible volume for display therein.

44. A method for displaying objects, comprising:
disposing an inner structure around a light source, the inner structure having a generally continuous outer peripheral surface;
disposing an outer surface around the inner structure, the outer structure having a generally continuous inner peripheral surface spaced from the outer peripheral surface of the inner structure to define an externally accessible volume therebetween; and
disposing one or more objects within the externally accessible volume for display therein.

45. The method of claim 44, further comprising:
coupling the light source and the outer structure to a base.

46. The method of claim 45, further comprising:
mounting the base to a stand.

47. The method of claim 44, wherein the light source comprises:
one or more light bulbs.

48. The method of claim 44, wherein the light source comprises:
one or more candles.

49. The method of claim 44, wherein the one or more objects comprise:
one or more objects selected from the group of objects comprised of papers, plastics, glasses, metals, woven fabrics, yarns, woods, rocks, minerals, leaves, flowers, beads, crystals, collectibles, and any combination thereof.

50. The method of claim 44, wherein the one or more objects comprise:
one or more objects selected from the group of objects comprised of pictures, paintings, films, photo artwork, graphics, graphic artwork, and prints.
